(19) United States
(12) Patent Application Publication
(10) Pub. No.: US 2011/0080660 A1
(43) Pub. Date: Apr. 7, 2011

(54) DEVICE FOR FACILITATING READING AS WELL AS A SHOPPING TROLLEY

(75) Inventor: Martin Kerle, Amberg (DE)

(73) Assignee: OPTIK KERLE GMBH, Amberg (DE)

(21) Appl. No.: 12/937,261

(22) PCT Filed: Apr. 9, 2009
(86) PCT No.: PCT/EP2009/054302

§ 371 Date: Dec. 5, 2010

(30) Foreign Application Priority Data
Apr. 9, 2008 (DE) 20 2008 004 888.5
May 8, 2008 (DE) 20 2008 006 362.0
Oct. 1, 2008 (DE) 10 2008 042 548.6
Oct. 24, 2008 (DE) 10 2008 043 184.2

(51) Int. Cl. B62B 3/00; G02B 7/02

(52) U.S. Cl. 359/809; 280/47.34; 359/811

(57) ABSTRACT

To an inventive shopping trolley 11 is attached a device 1 for facilitating the reading of printouts, labels etc. This has a magnifier 2, a weight 3, and a steel cable 4 which connects the magnifier 2 to the weight 3. Moreover, the device 1 has a receiving element 5, which in this case is formed as a metal tube. The upper area of the metal tube 5 has an opening 6 through which the steel cable 4 is guided. The weight 3 is always inside the metal tube 5. The gravitational force G of the weight 3 causes the magnifier 2 to be drawn via the steel cable 4 to the opening 6 and practically onto the metal tube 5. The steel cable 4 can be pulled out from the opening 6 against the restoring force G.

### FIELD OF THE INVENTION

The present invention relates to a device for facilitating the reading of printouts, labels, etc, comprising at least one vision aid. Furthermore, the invention relates to a shopping trolley comprising the aforementioned device.

### PRIOR ART

Every day, consumers everywhere are confronted with a plurality of printouts, for example, statements produced by automated teller machines, labels, e.g., on product packaging, etc. On account of statutory regulations, there is an emerging trend towards mandatory provision of increasingly detailed information about the ingredients of goods, e.g., foods, beverages, medicines, etc, with the result that the quantity of printed information on packaging is rising. The increased space requirement is frequently compensated by the use of a smaller font type.

For this reason, consumers often have difficulties reading the information on the spot, for example, at the point of sale. This affects not only consumers who have normal eyesight but especially also those with weaker eyesight, for example, the elderly or people with defective vision. While in many instances these people are in possession of vision aids, they may not have them to hand if necessary.

### OBJECT OF THE INVENTION

Proceeding therefrom, it is the object of the present invention to provide means for facilitating the reading of printouts, labels, etc that can be provided for use on the spot.

### TECHNICAL SOLUTION

This object is achieved by providing a device to facilitate reading in accordance with claim 1 and a shopping trolley in accordance with claim 23.

The inventive device for facilitating the reading of printouts, labels, etc. comprises at least one vision aid, and at least one attachment mechanism connected to the vision aid for attaching the vision aid to an object.

The vision aid in the proposed system is attached by means of the attachment mechanism to a mobile or stationary object, for example, a shopping trolley, a shopping basket, a display shelf, etc. The vision aid may be connected directly or indirectly to the attachment element. Moreover, the vision aid can be connected movably and immovably to the attachment element. What matters is that the vision aid cannot be easily removed from the object to which it is attached. This circumvents the risk of the vision aid's being stolen or accidentally removed from the object in whose vicinity it is needed.

The attachment mechanism can in principle comprise any appropriate means of attachment, for example, a clamp, a bolted joint, riveting, welding, an adhesive surface, a frame for clamping the vision aid, etc. In principle, the attachment of the vision aid to the attachment element can be arranged so as to be easily or not so easily removable, or so as to be permanent, i.e. non-removable.

In particular, the attachment mechanism is configured so as to allow the vision aid to be moved relative to the object to which it is attached. This increases the versatility of the vision aid in use because the user can manoeuvre the vision aid within a certain radius of the attachment element into a position in which a printout or label can be read with ease.

Preferably, the attachment mechanism comprises at least one base element for immovable attachment to the object and at least one connecting element, capable of moving relative to the base element, for connecting the base element to the vision aid. In this preferred embodiment of the invention, the vision aid is connected to the base element so as to be movable relative to it. In particular, the vision aid is connected to the base element via the connecting element. The connecting element can be flexible or bendable. It may, for example, be formed as a chain, cord, wire, steel cable or tape. The use of a more or less flexible connecting element renders the vision aid particularly convenient to use, since it can be moved right up against the printed object.

In particular, the vision aid can be connected to the base element so as to be movable between at least a first waiting position and a second deployment position. The vision aid can be arranged at the base element so as to be movable at least between the first (waiting/ready) position and the second (deployment) position. Thus, the vision aid can be arranged in the first position in the vicinity of the attachment element so as to be protected from damage, such as scratching, while it can be used in the second position for reading a label or a printout.

In a preferred embodiment of the invention, the attachment mechanism is configured such that the vision aid can rotate relative to the base element. The vision aid can be rotated between the first position, where it is located inside a protective cover, into the second position, where the labelled object can be maneuvered behind the vision aid so that it can be read.

In a particularly preferred embodiment, the attachment mechanism is configured such that the vision aid is connected to the attachment mechanism such that it can be relatively maneuvered away from and/or towards the base element. Such a movement may, for example, be effected by means of a pull-out mechanism or with the aid of a flexible connecting element, for example, a chain, a wire or a steel cable.

Preferably, the attachment mechanism has a return element which exerts a restoring force on the vision aid which has been moved out of the first waiting position. The mechanism for generating the restoring force serves to return the vision aid from the second position to the first position. So, if the vision aid or its handle is released, it is automatically retracted or pulled back towards the base element. This renders the device more convenient to handle since the user can simply let go of the vision aid after having used it in the second position. On account of the mechanism, the vision aid returns to the first position of its own accord, for example, to a receptacle in which it is protected from external influences.

The return element can be movably arranged such that the restoring force is generated by the return element's force of gravity.

In particular, the return element has a weight connected to the connecting element.

Especially, the return element is arranged so as to be movable relative to the base element.

The base element of the attachment mechanism can be configured as a tubular element for accommodating the return element.

Alternatively, the return element can have an elastic element for generating the restoring force.

In particular, the mechanism for generating a restoring force can have at least one roll-up mechanism for rolling up the connecting element. The roll-up mechanism can comprise a reel onto which the connecting element, for example, a chain or a cord, is rolled up by means of a return spring as soon as the vision aid is released. For example the return spring can be a coiled leaf spring. In addition, the roll-up mechanism ensures that a certain tensile force always acts on the pulled-out vision aid. Preferably, the return or roll-up mechanism is arranged inside the base part. The base part can have a housing with a hollow chamber for accommodating the connecting element and/or the vision aid.

In particular, the device can have at least one blocking element, which limits the movement distance of the vision aid relative to the base element.

Preferably, the base element of the attachment mechanism has a housing for accommodating at least one section of the connecting element and/or the vision aid.

In particular, the device can have at least one receiving element for accommodating the vision aid in a receiving chamber. The receiving element can be a spectacles wipe, a case, a plastic cover, etc.

In particular, at least part of the vision aid is accommodated in the receiving chamber in the first waiting position. In this way, as long as it is not removed from the receiving chamber and used, the vision aid is protected from external influences, such as damage and contamination.

In particular, the receiving element can be connected to the vision aid such that the receiving element with the vision aid are jointly arranged so as to be movable at the base element, such that they are arranged together at the base element and can move relative to it.

The receiving element can be connected to the vision aid such that the receiving element together with the vision aid is arranged at the base element and can be moved away from the base element and/or towards it.

The receiving element, however, can also be firmly attached to the base element. A firm connection in this context means that the receiving element cannot be removed relative to the base element. However, the receiving element can, for example, be rotatably connected to the base element thoroughly. The vision aid can thus be unfolded from or moved away from the receiving element.

In a preferred embodiment, the receiving element is firmly connected to the base part. In particular, the base part can be formed inside and as an integral part of the receiving element, respectively.

The vision aid can be movably arranged relative to the receiving element such that the vision aid can be moved into a position of use from a receiving position in which the vision aid is at least partially accommodated in the receiving chamber of the receiving element. The first receiving position can at least intermittently correspond to the first (waiting) position. The position of use can at least intermittently correspond to the second (deployment) position. The movement between the vision aid and the receiving element in this regard can be a relative rotary movement for unfolding the vision aid, a translational movement to deploy the vision aid from the receiving chamber and the like.

Preferably, the receiving element has at least one outer surface which has a field for labelling or for applying labelling. Thus the device can also be used for advertising.

In particular, the vision aid is a magnifier. The magnifier can, for example, be termed a shopping magnifier if arranged, for example, on a shopping trolley, a shop counter or a shopping basket in a shopping area. With the help of the magnifier, small labels on products or the small-print, e.g. on account statements, can be magnified and thus read more easily by a user.

The object is also achieved by the provision of a shopping trolley, a shopping basket or a display shelf, each of which has at least one device for facilitating reading, as described above. In this regard, the device for facilitating reading is attached to the shopping trolley, the shopping basket or the display shelf by means of the base element.

The device can be attached, for example, to the handle and/or the enclosing rod of a shopping trolley. The base element can even be provided as a part of the rod.

The invention can be realized in all sorts of combinations and variations of the described characteristics. In particular, all combinations of individual components described are claimed, irrespective of whether these are designed as separate components or several components as a one-piece component.

### BRIEF DESCRIPTION OF THE DRAWINGS

Further characteristics and advantages of the invention result from the following description of specific embodiments using the enclosed figures. The figures show in:

FIGS. 1a, 1b, 1c a first embodiment of the invention;

FIGS. 2a, 2b two different embodiments of a detail of the invention;

FIG. 3 an inventive shopping trolley;

FIG. 4 one way to use the inventive device;

FIG. 5 a second embodiment of the inventive device

FIG. 6 a third embodiment of the inventive device

FIG. 7 a fourth embodiment of the inventive device,

FIG. 8 a fifth embodiment of the inventive device, and

FIGS. 9a, 9b and 9c the embodiment of FIG. 1 having additional technical features.

### DESCRIPTION OF SPECIAL EMBODIMENTS

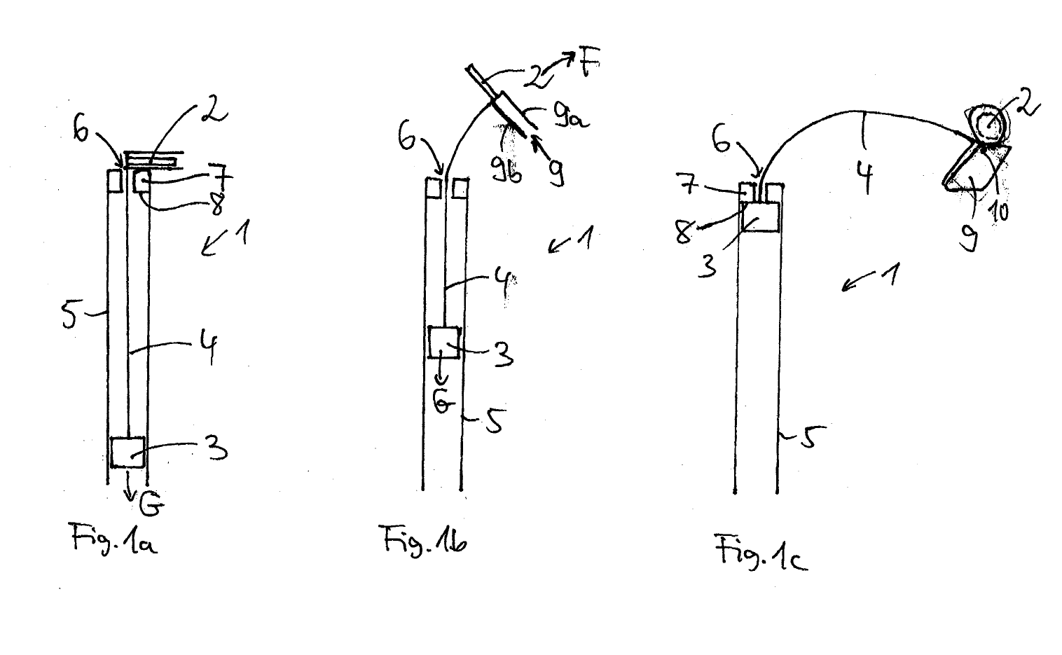

FIGS. 1a, 1b and 1c show an inventive device 1 for facilitating the reading of printouts, labels, etc., in different states.

The device 1 comprises a magnifier 2, a weight 3, and a steel cable 4 which connects the magnifier 2 to the weight 3. In addition, the device 1 has a receiving element 5, which in this case is formed as a metal tube. At the top of the metal tube 5 is an opening 6, through which the steel cable 4 is guided. The opening 6 is limited by an annular closing element 7. The underside of the closing element 7 constitutes a stop 8.

The weight 3 is always inside the metal tube 5. FIG. 1a also depicts the largest part of the steel cable 4 arranged inside the metal tube 5. The gravitational force G of the weight 3 causes the magnifier 2 to be drawn via the steel cable 4 to the opening 6 and practically onto the metal tube 5. Instead of the gravitational force G of the weight 3, other mechanisms could also be used to generate a restoring force, for example, a spring to produce an elastic restoring force. The steel cable 4 can be pulled out from the opening 6 against the restoring force G.

From FIG. 1b it is clear that the magnifier 2, the steel cable 4 and the weight 3 are arranged so as to be movable relative to the metal tube 5. The magnifier 2 can thus, by the exertion of a force F, which counters the gravitational force G of weight 3, be removed from the opening 6 and used at a desired point of use.

For use, the magnifier 2, which is rotatably arranged about an axis of rotation 10 relative to the protective cover 9 with an upper cover 9a and a lower cover 9b, is swiveled out from the protective cover 9 in order to be deployed.

FIG. 1c illustrates a situation in which the weight 3 makes contact with the stop 8 of the annular closing element 7, wherein the magnifier 2, which has been swiveled out from the protective cover, is arranged at a maximum distance from the opening 6.

The construction 1 is so stable overall that it is not possible to pull the weight 3 out of the metal tube 5 or to steal the magnifier 2. This allows the device 1 to be installed at various public places or objects, such as shopping trolleys, shopping baskets, etc, which can be used by everyone.

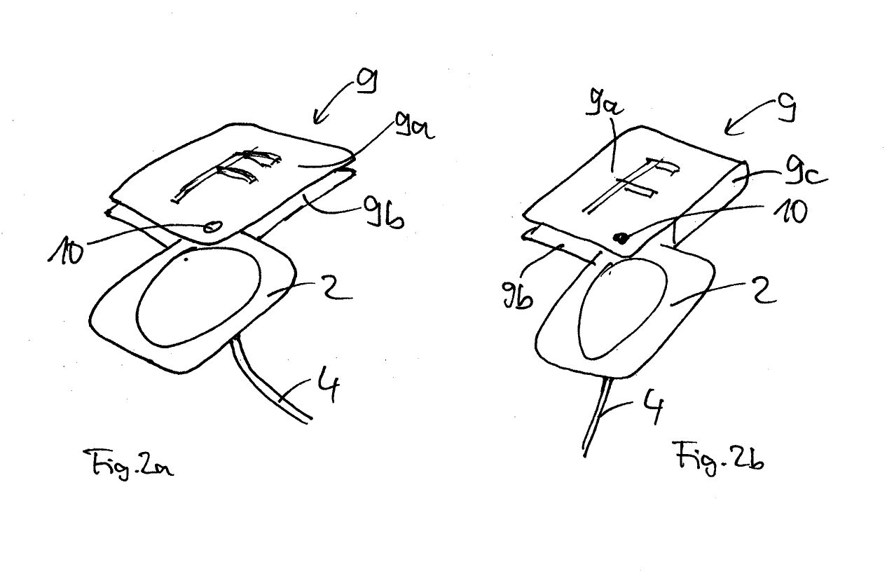

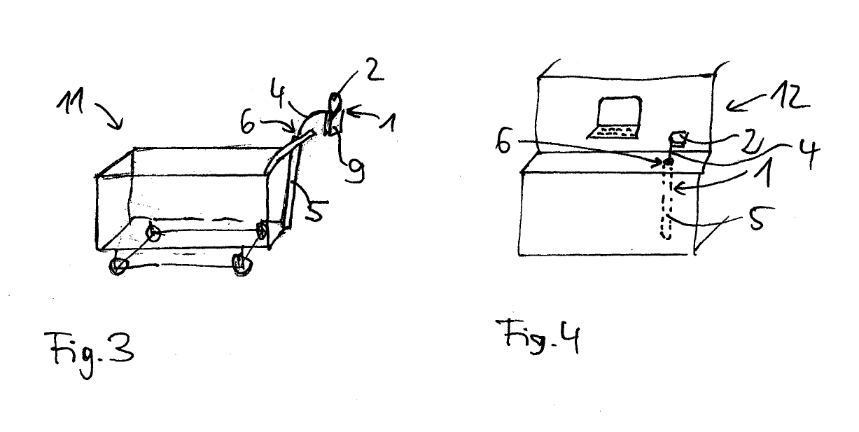

FIG. 2a shows a first embodiment of the protective cover 9, which has an upper cover 9a and a lower cover 9b. The magnifier 2 in this embodiment is swiveled out from the protective cover 9 into the deployment position. The swivel axle 10 corresponds to the end region of the steel cable 4 or attaches to the end region of the steel cable 4.

The protective cover 9 can be made, for example, of leather, artificial leather, plastic or similar materials. From FIG. 2a, it is clear that the upper side of the upper cover 9a of the protective cover 9 (as well as the underside of the lower cover 9b of the protective cover 9) can be used as an advertising space, marked by the letters F. The advertising can be affixed directly to the protective cover 9 in the form of plastic film or plastic sheet.

FIG. 2b shows an embodiment in which the protective cover 9 consists of a plastic housing which has an upper side 9a, a lower side 9b and sidewall 9c, which connects areas of the upper side 9a and the lower side 9b. The magnifier 2 is rotatably arranged about a rotary axis 10 relative to the protective cover 9.

FIG. 3 shows an inventive shopping trolley 11 at which is arranged a device 1, as described in connection with FIGS. 1a, 1b, 1c, 2a and 2b. The metal tube 5 is permanently attached to the shopping trolley 11, forms a rod on the shopping trolley or is integrated into a rod of the shopping trolley 11. The metal tube 5 can be used to affix, for example, advertising, too.

The steel cable or wire rope 4 in this embodiment is partially pulled out from the steel tube 5, such that the magnifier 2, which is swiveled out from the protective cover 9, can be used.

FIG. 4 shows an embodiment in which the magnifying device 1 is integrated into an automated teller machine 12. In this connection, the metal tube 5 is integrated inside the automated teller machine 12. Via the steel cable 4, the magnifier can be pulled out from the opening 6 by the user as far as the stop of the weight 3 at stop 8 (not shown) in order that, for example, account statements may be easier to read with the help of the magnifier 2.

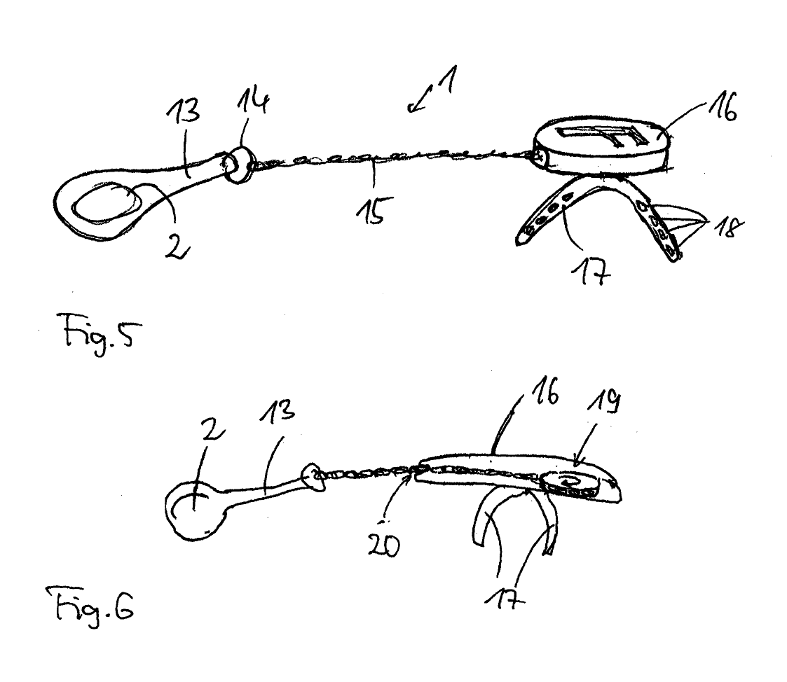

FIG. 5 shows a further embodiment of an inventive device 1 for facilitating the reading of printouts, labels, etc. The device 1 comprises a magnifier 2 with a handle 13 arranged at it. The handle 13 of the magnifier 2 is connected to a base part 16 via a connecting ring 14 and a connecting chain 15. At the base part 16 is arranged an attachment element in the form of a clamp 17 with openings 18 for bolting the attachment element 17 to an object (not shown).

Inside the base part 16, a roll-up mechanism for the connecting chain 15 is provided which, as long as there is no tension on the magnifier 2, automatically rolls the chain 15 up into a roll arranged in the base part 16 (not shown). The restoring force is generated, for example, by a leaf spring.

The chain 15 can be flexibly bent so that the magnifier 2 can be conveniently maneuvered towards product packaging or other printed area. The length of the chain 15 determines how far the magnifier 2 can be moved away from the attachment element 17 of the base part 16. A maximum pull-out distance can be in the range 0.25 to 0.75 m, especially about 0.5 m, depending on the application. In the waiting position, that is, without tensile load, the entire chain 15 is rolled up completely inside the housing of the base part 16. The surface of the base part 16, may be used for affixing a message, as indicated by the letter F.

FIG. 6 shows a further particularly preferred embodiment of the invention. A roll-up mechanism 19 is integrated inside a base part 16. The attachment elements 7 are arranged at the base element 16. The magnifier 2 with the handle 13 is drawn at least extensively into the receiving opening 20 when the handle 13 of the magnifier 2 is released. The chain 15 is kept under tension by the roll-up mechanism and, when the handle 13 and the magnifier 2 are released, is rolled up by the roll-up mechanism. Instead of the roll-up mechanism, another described return mechanism may be provided.

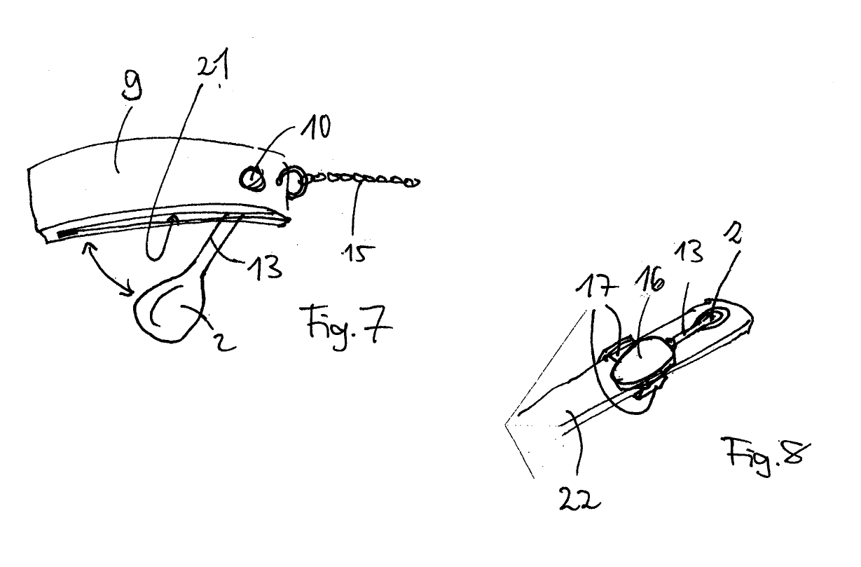

FIG. 7 shows an embodiment in which the handle 3 is rotatably arranged at a receptacle 9 with an interior chamber 21 for the purpose of at least partly receiving the magnifier 2. The receptacle 9 and the magnifier 2 are connected to a base element (not shown) via a chain 15, such as is shown in FIG. 1.

The rotary mechanism between the handle 3 and the receptacle 13, too, may be fitted with a smooth restoring mechanism which rotates the magnifier 2 into the receiving opening 21 as soon as the magnifier 2 is released.

FIG. 8 shows a handle 22 of an inventive shopping trolley to which a magnifier 2 is attached. In the illustration, the magnifier 2 is shown in the waiting state. This means that the chain is rolled up inside the housing of the base part 16 out of sight of the viewer. The base part 16 is affixed to the handle 22 of the shopping trolley via the attachment means 17.

During use, the user can grip the magnifier 2 by the handle 13 and manoeuvre it away from the handle 22 of the shopping trolley 1 towards product packaging to make it easier to read a certain printed section on the product packaging.

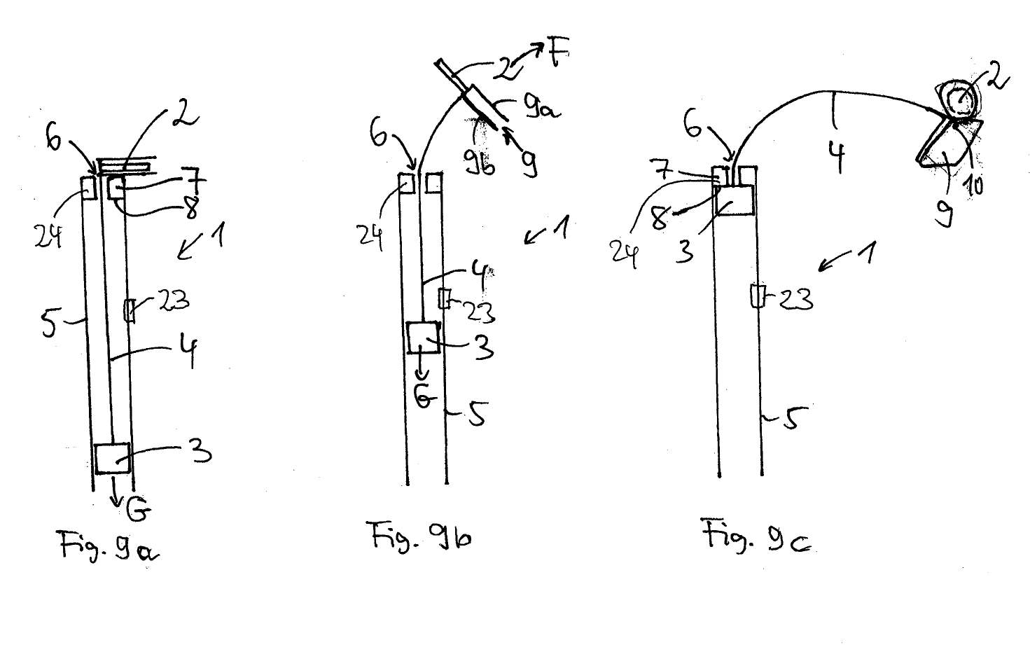

FIGS. 9a, 9b and 9c illustrate the inventive device 1 according to FIGS. 1a, 1b and 1c having additional features. The features described in connection with FIGS. 1a, 1b and 1c are also implemented in the device according to FIGS. 9a, 9b and 9c. Additionally, the device 1 comprises a sensor 23 arranged at or in the receiving element 5. The sensor detects the approach or the passing by of the weight 3 when the magnifier 2 is pulled away from the receiving element 5, and a sound chip 24 is activated by the sensor 23 to output an advertising message. The sensor 23 may, for example, be a contact sensor having a contact which is contacted by the weight or another contact connected with the weight when the weight passes the contact sensor. The sensor 23 may also be an optical sensor (e.g. being activated by means of a photosensor), a magnetic sensor (wherein a magnet is arranged at the weight, which causes an inductive voltage in an inductor arranged at the receiving element 5, a contact sensor which reacts when the weight 3 contacts the stop of the closing element 7, or the sensor may be any kind of sensor suitable for sensing a movement of the magnifier 2 relative to the receiving element 5.

In the present embodiment the sound chip 24 is not activated in the state indicated in FIGS. 9a and 9b, while in FIG. 9c the sound chip 24 has been activated and outputs information acoustically.

In the present embodiment the sound chip 24 is arranged in the closing element 7, separate from the sensor 23. The sensor 23 and the sound chip 24 may also be arranged close to each other, or they may be integrally formed and arranged at an arbitrary position within the device 1.

In another embodiment of the invention the sensor 23 and the sound chip 24 may be arranged separate from the other components of the device 1. The sensor 23 may also be arranged at the weight 3 or at the steel cable 4.

By means of sound chip 24 a message may be output acoustically when pulling the magnifier 2 away from the receiving element 5. Therefore, the device 1 is excellent advertising medium which may influence a user of the device optically and acoustically, and at the same time be a useful tool. The use of sound chip may be implemented connection with any of the embodiments described above.

1. A device (1) for facilitating the reading of printouts, labels, etc, comprising:
at least one vision aid (2); and
at least one attachment mechanism connected to the vision aid (2) for attaching the vision aid (2) to an object (11, 12).

2. The device (1) of claim 1, wherein
the attachment mechanism is configured so as to allow the vision aid (2) to be moved relative to the object (11, 12) to which it is attached.

3. The device (1) of claim 1, wherein
the attachment mechanism comprises at least a base element (5, 16) for immovable attachment to the object (11, 12) and at least one connecting element (4, 15), capable of moving relative to the base element (5, 16), for connecting the base element (5, 16) to the vision aid (2).

4. The device (1) of claim 3, wherein the vision aid (2) is movably connected to the base element (5, 16) between at least a first waiting position and a second deployment position.

5. The device (1) of claim 3, wherein the attachment mechanism is configured for rotatable arrangement of the vision aid (2) relative to the base element (5, 16).

6. The device (1) of claim 3, wherein the attachment mechanism is configured such that the vision aid (2) can be maneuvered away from and/or towards the base element (5, 16).

7. The device (1) of claim 4, wherein
the attachment mechanism has a return element (3, 19) which exerts a restoring force on the vision aid (2) which has been moved out of the first waiting position.

8-11. (canceled)

12. The device (1) of claim 7, wherein the return element (3) has a mechanism for generating the restoring force.

13. The device (1) of claim 12, wherein the mechanism for generating a restoring force has at least one roll-up mechanism for rolling up the connecting element (15).

14. The device (1) of claim 3, further comprising
at least one blocking element (6), which limits the movement distance of the vision aid (2) relative to the base element (5, 16).

15. The device (1) of claim 3, wherein the base element (5, 16) of the attachment mechanism has a housing (9, 16) for accommodating at least one section of the connecting element (4, 15) and/or the vision aid (2).

16. The device (1) of claim 4, further comprising
at least one receiving element (9) for receiving the vision aid (2) in a receiving chamber.

17. The device (1) of claim 16, wherein
the vision aid (2) is at least partially accommodated in the receiving chamber in the first waiting position.

18. The device (1) of claim 16, wherein
the receiving element (9) together with the vision aid (2) is movably arranged at the base element (5, 16).

19. The device (1) of claim 16, wherein
the receiving element (9) is connected to the vision aid (2) such that the receiving element (9) together with the vision aid is arranged at the base element (5, 16) and can be moved away from the base element (5, 16) and/or towards it.

20. The device (1) of claim 16, wherein
the vision aid (2) is movably arranged relative to the receiving element (9) such that the vision aid (2) can be moved into a position of use from a receiving position in which the vision aid (2) is at least partially accommodated in the receiving chamber of the receiving element (9).

21. (canceled)

22. The device (1) of claim 1, wherein
the vision aid (2) is a magnifier.

23-29. (canceled)

30. A shopping trolley (9), comprising at least one device (1) for facilitating reading in accordance with of claim 1.

31. The shopping trolley of claim 30, wherein
said device (1) for facilitating reading is attached to said trolley by means of a base element (5, 16).

32. (canceled)
